(19) United States
(12) Patent Application Publication
(10) Pub. No.: US 2025/0058670 A1
(43) Pub. Date: Feb. 20, 2025

(54) CHARGING SEQUENCE CONTROL SYSTEMS AND METHODS FOR CHARGING STATIONS

(71) Applicant: GM GLOBAL TECHNOLOGY OPERATIONS LLC, Detroit, MI (US)

(72) Inventors: Xiang ZHAO, Novi, MI (US); Dalong GAO, Rochester, MI (US)

(21) Appl. No.: 18/233,477

(22) Filed: Aug. 14, 2023

(51) Int. Cl. B60L 53/67; B60L 53/36; B60L 53/62; B60L 53/66; B60L 53/68; G06Q 20/10

(52) U.S. Cl. CPC B60L 53/67; B60L 53/36; B60L 53/62; B60L 53/665; B60L 53/68; G06Q 20/102

(57) ABSTRACT

A vehicle charging control system includes: a charging location including N parking locations for vehicles and M vehicle chargers, where N is an integer greater than or equal to two and M is an integer less than N and greater than or equal to 1; and a charging control module configured to set a charging sequence for charging vehicles at the charging location based on at least two of: (a) arrival times of the vehicles, respectively, to the charging location; (b) expected departure times of the vehicles, respectively, from the charging location; (c) charge levels of batteries of the vehicles, respectively, at arrival to the charging location; (d) target charge levels of the batteries of the vehicles, respectively, at departure from the charging location; (e) credits of users of the vehicles, respectively; and (f) premium fees approved by the users of the vehicles, respectively, for advancing in the charging sequence.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to charging stations for vehicles and more particularly to systems and methods for determining charging sequences and periods of charging for vehicles at charging stations.

Power distributions systems for electric vehicles include stationary charging stations that are capable of charging electric vehicles parked nearby the charging stations. For example, the charging stations may include a power cord that is used to electrically connect the battery of an electric vehicle with a power source such as an electrical grid. Vehicles move to the location of a stationary charging station for charging of the vehicles.

Another type of charging station includes mobile charging stations. In the example of mobile charging stations, the mobile charging stations move to the location of a vehicle for charging of the vehicle.

### SUMMARY

In a feature, a vehicle charging control system includes: a charging location including N parking locations for vehicles and M vehicle chargers, where N is an integer greater than or equal to two and M is an integer less than N and greater than or equal to 1; and a charging control module configured to set a charging sequence for charging vehicles at the charging location based on at least two of: (a) arrival times of the vehicles, respectively, to the charging location; (b) expected departure times of the vehicles, respectively, from the charging location; (c) charge levels of batteries of the vehicles, respectively, at arrival to the charging location; (d) target charge levels of the batteries of the vehicles, respectively, at departure from the charging location; (e) credits of users of the vehicles, respectively; and (f) premium fees approved by the users of the vehicles, respectively, for advancing in the charging sequence.

In further features, the charging control module is further configured to move the vehicles to locations of the M vehicle chargers according to the charging sequence and to actuate the vehicle chargers to electrically connect the vehicle chargers to the vehicles.

In further features, the charging control module is further configured to move the vehicle chargers to locations of the N vehicles according to the charging sequence and to actuate the vehicle chargers to electrically connect the vehicle chargers to the vehicles.

In further features, the charging control module is configured to determine the charging sequence based on at least three of (a)-(f).

In further features, the charging control module is configured to determine the charging sequence based on all of (a)-(f).

In further features, the charging control module is configured to advance a time for starting charging of one of the vehicles in the charging sequence when the expected departure time of the vehicle is before the expected departure times of the other vehicles.

In further features, the charging control module is configured to delay a time for starting charging of one of the vehicles in the charging sequence when the expected departure time of the vehicle is after the expected departure times of the other vehicles.

In further features, the charging control module is configured to advance a time for starting charging of one of the vehicles in the charging sequence when the charge level of the vehicle is less than the expected charge levels of the other vehicles.

In further features, the charging control module is configured to delay a time for starting charging of one of the vehicles in the charging sequence when the charge level of the vehicle is greater than the charge levels of the other vehicles.

In further features, the charging control module is configured to receive (e) and (f) from mobile devices of users of the vehicles, respectively, via a network.

In further features, the charging control module is configured to advance a time for starting charging of one of the vehicles in the charging sequence in response to receipt of user input indicative of an acceptance by a user associated with the one of the vehicles of use of a number of credits of the user.

In further features, the charging control module is configured to advance a time for starting charging of one of the vehicles in the charging sequence in response to receipt of user input indicative of an acceptance by a user associated with the one of the vehicles for payment of a fee for the advancement.

In further features, the vehicles are electric vehicles.

In further features, the vehicles are each at least partially autonomous.

In further features, (d) the target charge levels of the batteries of the vehicles, respectively, at departure from the charging location are fixed predetermined values.

In further features, (d) the target charge levels of the batteries of the vehicles, respectively, at departure from the charging location are set based on user input from mobile devices associated with the vehicles, respectively.

In further features, the charging control module is configured to determine the (b) expected departure times of the vehicles, respectively, from the charging location based on average parking periods of the vehicles, respectively, at the charging location.

In further features, the charging control module is configured to set the expected departure times of the vehicles based on (a) the arrival times of the vehicles, respectively, to the charging location and the average parking periods of the vehicles, respectively, at the charging location.

In further features, the charging control module is configured to receive the (b) expected departure times of the vehicles, respectively, from the charging location from mobile devices of users associated with the vehicles, respectively.

In a feature, a vehicle charging control method includes: providing, at a charging location, N parking locations for vehicles and M vehicle chargers, where N is an integer greater than or equal to two and M is an integer less than N and greater than or equal to 1; and setting a charging sequence for charging vehicles at the charging location based on at least two of: (a) arrival times of the vehicles, respectively, to the charging location; (b) expected departure times of the vehicles, respectively, from the charging location; (c) charge levels of batteries of the vehicles, respectively, at arrival to the charging location; (d) target charge levels of the batteries of the vehicles, respectively, at departure from the charging location; (e) credits of users of the vehicles, respectively; and (f) premium fees approved by the users of the vehicles, respectively, for advancing in the charging sequence.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a functional block diagram of an example charging system;

FIG. 2 is a functional block diagram of an example charging system;

FIG. 3 is a front view of an example implementation of a mobile computing device;

FIG. 4 is a functional block diagram of an example implementation of a mobile computing device;

FIG. 5 is a flowchart depicting an example method of determining a charging sequence for vehicles at a charging location; and

FIG. 6 is an example graph of a charging sequence for vehicles over time.

In the drawings, reference numbers may be reused to identify similar and/or identical elements.

### DETAILED DESCRIPTION

A charging facility (e.g., lot) for vehicles includes multiple parking locations (spots) for multiple different vehicles. The charging station also includes one or more vehicle chargers, such as direct current (DC) chargers. The charging station includes less vehicle chargers than parking locations. As such, not all vehicles at a charging station can be charged at one time.

The present application involves systems and methods to determine charging sequences and periods for charging vehicles at a charging facility. A charging sequence module determines a charging sequence in which to charge vehicles at the charging facility based on vehicle arrival time, vehicle expected departure times, battery power level of the vehicles at arrival, battery lower level of the vehicles at the expected departure, battery capacity of the vehicles, vehicle average park time, credits of users of the vehicles for moving forward in charging sequence, and premium fees that the user is willing to pay for moving forward in the charging sequence. This generates an optimum charging sequence given the multitude of inputs.

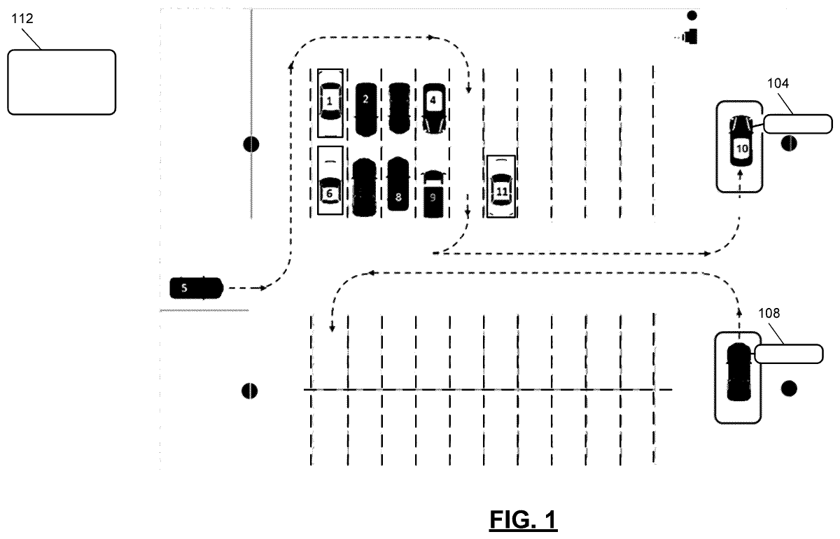

FIG. 1 is a functional block diagram of an example charging system. A charging facility including N parking locations (spots) for vehicles is shown where N is an integer greater than 1. In the example of FIG. 1, the charging facility includes 40 different parking locations for vehicles (N=40).

Users (e.g., owners, managers, etc.) of vehicles bring the vehicles to the charging facility for charging of batteries (or battery packs) of the vehicles. In various implementations, the vehicles to be charged may be fully electric vehicles that do not include an internal combustion engine or hybrid vehicles including both one or more electric motors for propulsion and an internal combustion engine.

The charging facility includes M chargers where M is an integer greater than or equal to 1. In the example of FIG. 1, the charging facility includes 2 chargers (M=2), charger 104 and charger 108. Because there are less chargers than parking locations (N>M), not all vehicles may be able to be charged at the same time.

A charging control module 112 determines a charging sequence in which to charge vehicles at the parking facility based on multiple different parameters as discussed further below. In the example of FIG. 1, the circles denote one or more perception sensors, such as camera, light detection and ranging (LIDAR) sensors, and/or one or more other types of perception sensors.

Each vehicle to be charged at the charging facility can be partially or fully autonomous in that it is configured to, without driver input, move forward, backward, and steer based on input from sensors of the vehicle. The charging control module 112 controls a vehicle to move (move forward, backward, steer) that vehicle to the location of the charger to be used to charge that vehicle (104 or 108). The charging control module 112 may also move vehicles to parking locations prior to being charged without driver input.

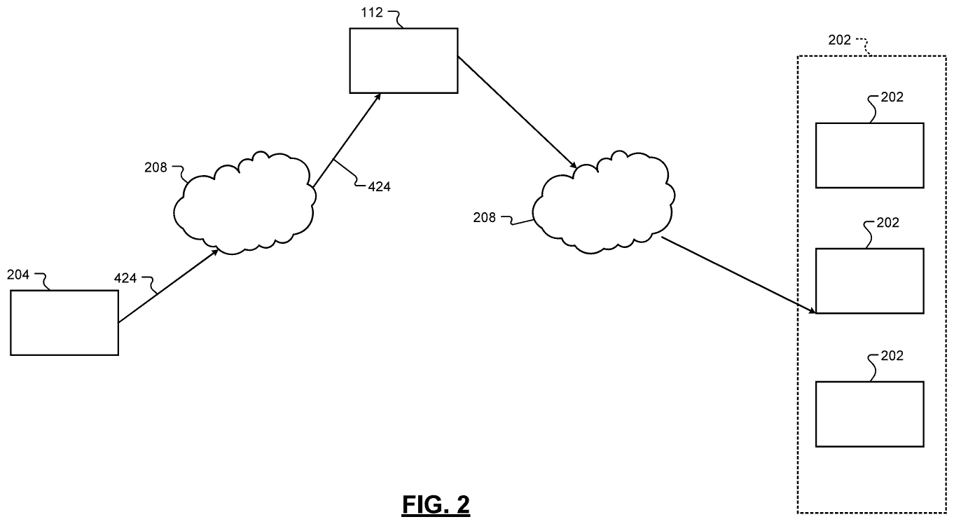

FIG. 2 is a functional block diagram of an example charging system including the charging control module 112. The charging control module 112 receives charging requests and charging information for a plurality of vehicles 202.

The charging control module 112 receives charging requests from mobile devices, such as mobile device 204. Examples of mobile devices include mobile phones, tablet devices, laptop computers, desktop computers, and other types of computing devices. Mobile devices, vehicles, and the charging control module 112 communicate via one or more networks 208. The networks 208 may include wireless networks or a combination of wireless and wired networks.

The charging control module 112 determines a charging sequence for charging vehicles at the charging location based on information received.

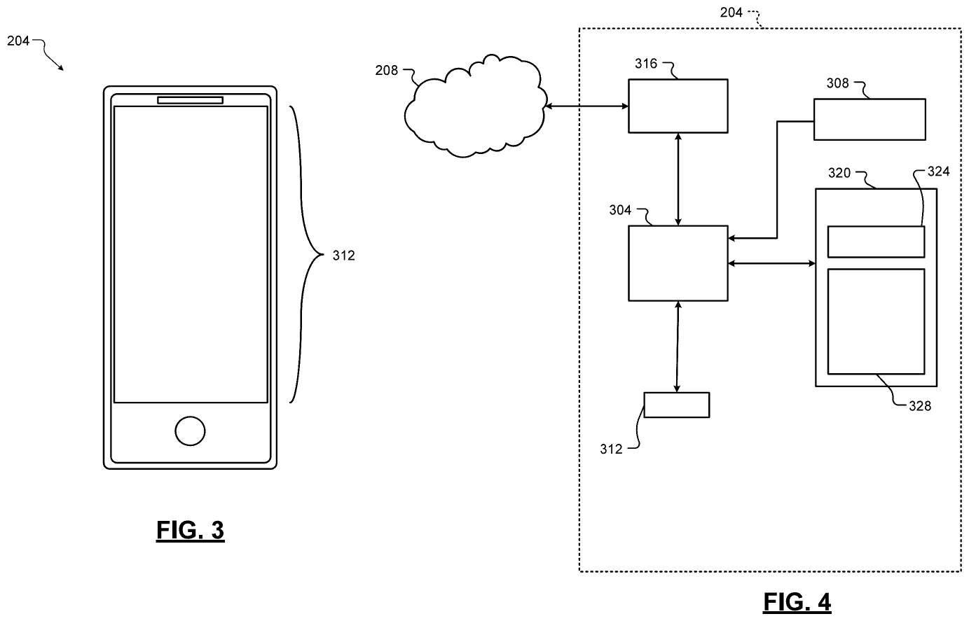

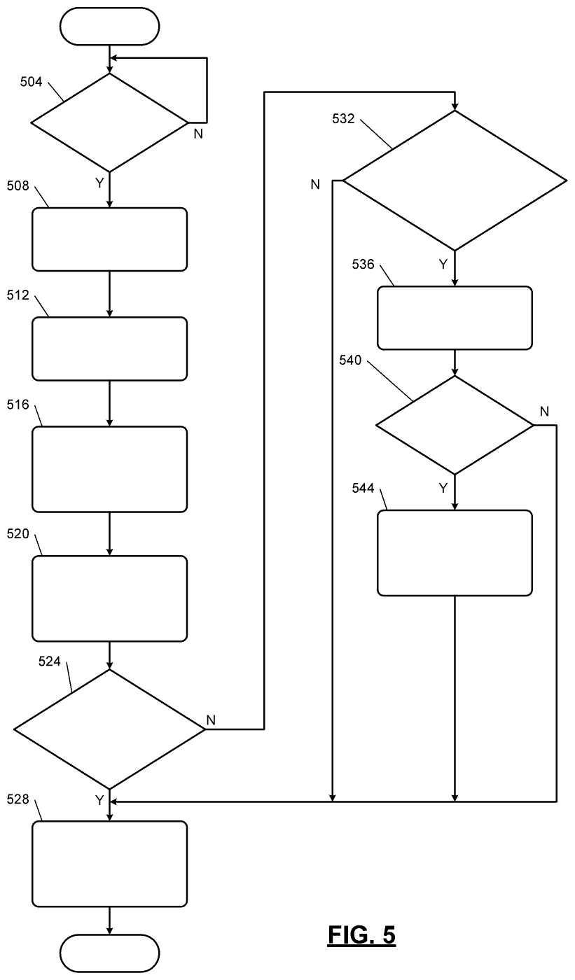

FIG. 3 includes a front view of an example implementation of the mobile device 204. FIG. 4 includes a functional block diagram of an example implementation of the mobile device 204. Referring to FIGS. 3 and 4, the mobile device 204 includes a central processing unit (CPU) or processor 304, one or more input devices 308 (e.g., touchscreen display, a microphone, one or more switches, etc.), a display 312 (e.g., the touchscreen display), one or more other output devices (not shown), a network interface 316, and memory 320. While the input devices 308 and the display 312 are illustrated as components of the mobile device 204, input devices and output devices (e.g., a display) may be peripheral devices. Also, while the example of a single processor is provided, the mobile device 204 may include two or more processors.

The network interface 316 connects the mobile device 204 to the networks 208. For example, the network interface 316 may include a wired interface (e.g., an Ethernet interface) and/or a wireless interface (e.g., a WiFi, Bluetooth, near field communication (NFC), or other wireless interface). The processor 304 of the mobile device 204 executes an operating system (OS) 324 and one or more other applications. The processor 304 executes a charging application 328 to manage charging of a vehicle. Operations discussed herein as being performed by the mobile device 204 are performed by the mobile device 204 (more specifically the processor 304) during execution of the charging application 328. Another instance of the charging application may be executed in vehicle, for example, within and by an infotainment module of the vehicle. The infotainment module may receive user input regarding charging using that charging application.

The mobile device 204 generates charging information based on user input to the mobile device 204 and transmits the charging information to the charging control module 112. The charging information may include, for example, an arrival time of the vehicle at the charging location (tₐ), a battery power capacity of the battery of the vehicle (BC), a remaining power of the battery of the vehicle at arrival at the charging location (Pₐ), and an expected departure time of the vehicle from the charging location (t_{d}). The charging information may also include a (e.g., target) battery power level at a departure time of the vehicle from the charging location (P_{d}), an average parking time of the vehicle (PT_{avg}), a present number of credit points of a user associated with the vehicle (CP), and a premium fee that the user is willing to pay for faster charging (than the standard charging sequence determined by the charging control module 112) (PF).

The arrival time of the vehicle at the charging location may be captured (e.g., via the perception sensors, etc.) by the charging control module 112 when the vehicle arrives at the charging location. The battery power capacity of the vehicle may be determined by the charging control module 112, for example, based on a unique identifier (e.g., a vehicle identification number (VIN)) of the vehicle. The mobile device may transmit the unique identifier or the battery power capacity. The expected departure time (and possibly date) may be transmitted by the mobile device based on user input to the mobile device. In various implementations, the departure timing may be determined by the mobile device or the charging control module 112, for example, based on an average charging time, which may be an average time spent by the vehicle during each stop at a charging location. The battery power level at the departure time may be, for example, transmitted by the mobile device based on user input to the mobile device. The battery power level at the departure time may be, for example, a target state of charge (SOC). In various implementations, the battery power level at the departure time may be a predetermined SOC, such as 85% SOC or another suitable value. The average parking time may be, for example, an average time that the vehicle is parked at the specific parking location. The present number of credit points of the user associated with the vehicle may be tracked by the charging control module 112 and given by the charging control module, for example, in response to the user accepting a request to be delayed in the standard charging sequence via the mobile device. The premium fee that the user is willing to pay for faster charging (than the standard charging sequence determined by the charging control module 112) may be transmitted by the mobile device and received by the mobile device based on user input to the mobile device. The premium fee may be, for example, a predetermined fixed rate (e.g., dollars per hour) or may be user specified (e.g., in an auction like situation).

The charge control module 112 determines the charging sequence using one or more equations that relate the charging information to charging sequences. For example, the charge control module 112 may determine the charging sequence (CS) using the equation:

CS=f(t_{a_i}),t_{d_i},P_{a_i},P_{d_i},BCᵢ,CTᵢ,PT_{avg_i},CPᵢ,PFᵢ),

where i refers to the i-th vehicle at the charging location.

The charging sequence includes a time sequence and order in which to charge each vehicle at the parking location and a period of time during which to charge each vehicle. When a vehicle at the parking location is to be charged, the charging control module 112 moves the vehicle to the location of a charger or a charger to the location of the vehicle. Once the vehicle to be charged is at the location of the charger or vice versa, the charging control module 112 actuates the charger to electrically connect to the vehicle and begin charging.

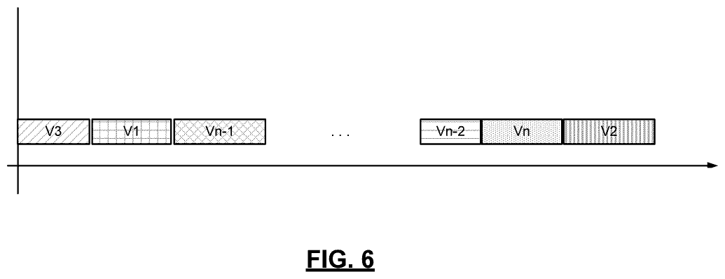

FIG. 5 is a flowchart depicting an example method of controlling charging and determining a charging sequence for charging vehicles at a charging location. Control begins with 504 where the charging control module 112 determines whether a vehicle has arrived at the charging location. If 504 is true, control continues with 508. If 504 is false, control may remain at 504. In various implementations, a driver of the vehicle may exit the vehicle upon arrival at the charging location, and the charging control module 112 may control the vehicle to move the vehicle to a parking location.

At 508, the charging control module 112 captures the arrival time of the vehicle at the charging location and the present power level (e.g., SOC) of the battery of the vehicle at the arrival time at the charging location. At 512, the charging control module 112 obtains the charging information from the mobile device associated with the vehicle or based on information from the mobile device associated with the vehicle.

At 516, the charging control module 112 may determine a charge period (of time) of charging of the vehicle to charge the battery of the vehicle to the target departure charge level of the battery. The charging control module 112 may, for example, determine a difference between the present power level of the battery at arrival and the target departure charge level of the battery and determine the charge period based on the difference. The charging control module 112 may determine the charge period, for example, using an equation or a lookup table that relates the difference to charge periods for a charging rate of the charger to be used for the charging.

At 520, the charging control module 112 determines the charging sequence for charging of the vehicles at the charging location based on the charging information received, captured, determined, etc. The charging control module 112 may transmit the charging sequence and an expected charging period (e.g., time range) to the mobile device associated with the vehicle. The mobile device may output the charging sequence and the expected charging period, for example, visually via a display of the mobile device and/or audibly via a speaker of the mobile device.

At 524, the charging control module 112 may determine whether the starting time of the expected charging period is at or before the expected departure time of the vehicle from the charging location. If 524 is true, the charging control module 112 may charge the vehicles in the charging sequence at 528. If 524 is false, control may transfer to 532. At 532, the charging control module 112 may determine whether a user input request to advance (e.g., move forward in time) the charging of vehicle has been received, such as from the mobile device. If 532 is true, control may continue with 536. If 532 is false, control may continue with 528 and leave the determined charging sequence unchanged.

At 536, the charging control module 112 may determine the number of credit points (CP) and/or premium fee (PF) associated with the requested advancing of the charging of the vehicle. This may be, for example, a predetermined number of credit points per predetermined period advanced, a premium fee per predetermined period advanced, or a combination of credit points and premium fee per predetermined period advanced. The charging control module 112 may transmit the number of credit points and/or premium fee to the mobile device associated with the vehicle. The mobile device may output the number of credit points and/or premium fee, for example, visually via a display of the mobile device and/or audibly via a speaker of the mobile device.

At 540, the charging control module 112 may determine whether user input has been received indicative of the user accepting the number of credit points and/or premium fee to be used to advance in the charging sequence. If 540 is true, at 544 the charging control module 112 adjusts the charging sequence at 544 to advance the (e.g., beginning time of) charging of the vehicle in the charging sequence and control continues with 528. If 540 is false, control may continue with 540 and leave the charging sequence unchanged.

FIG. 6 includes an example graph illustrating an example charging sequence of vehicles V1-Vn over time.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. A vehicle charging control system comprising:
a charging location including N parking locations for vehicles and M vehicle chargers, where N is an integer greater than or equal to two and M is an integer less than N and greater than or equal to 1; and
a charging control module configured to set a charging sequence for charging vehicles at the charging location based on at least two of:
(a) arrival times of the vehicles, respectively, to the charging location;
(b) expected departure times of the vehicles, respectively, from the charging location;
(c) charge levels of batteries of the vehicles, respectively, at arrival to the charging location;
(d) target charge levels of the batteries of the vehicles, respectively, at departure from the charging location;
(e) credits of users of the vehicles, respectively; and
(f) premium fees approved by the users of the vehicles, respectively, for advancing in the charging sequence.

2. The vehicle charging control system of claim 1 wherein the charging control module is further configured to move the vehicles to locations of the M vehicle chargers according to the charging sequence and to actuate the vehicle chargers to electrically connect the vehicle chargers to the vehicles.

3. The vehicle charging control system of claim 1 wherein the charging control module is further configured to move the vehicle chargers to locations of the N vehicles according to the charging sequence and to actuate the vehicle chargers to electrically connect the vehicle chargers to the vehicles.

4. The vehicle charging control system of claim 1 wherein the charging control module is configured to determine the charging sequence based on at least three of (a)-(f).

5. The vehicle charging control system of claim 1 wherein the charging control module is configured to determine the charging sequence based on all of (a)-(f).

6. The vehicle charging control system of claim 1 wherein the charging control module is configured to advance a time for starting charging of one of the vehicles in the charging sequence when the expected departure time of the vehicle is before the expected departure times of the other vehicles.

7. The vehicle charging control system of claim 1 wherein the charging control module is configured to delay a time for starting charging of one of the vehicles in the charging sequence when the expected departure time of the vehicle is after the expected departure times of the other vehicles.

8. The vehicle charging control system of claim 1 wherein the charging control module is configured to advance a time for starting charging of one of the vehicles in the charging sequence when the charge level of the vehicle is less than the expected charge levels of the other vehicles.

9. The vehicle charging control system of claim 1 wherein the charging control module is configured to delay a time for starting charging of one of the vehicles in the charging sequence when the charge level of the vehicle is greater than the charge levels of the other vehicles.

10. The vehicle charging control system of claim 1 wherein the charging control module is configured to receive (e) and (f) from mobile devices of users of the vehicles, respectively, via a network.

11. The vehicle charging control system of claim 1 wherein the charging control module is configured to advance a time for starting charging of one of the vehicles in the charging sequence in response to receipt of user input indicative of an acceptance by a user associated with the one of the vehicles of use of a number of credits of the user.

12. The vehicle charging control system of claim 1 wherein the charging control module is configured to advance a time for starting charging of one of the vehicles in the charging sequence in response to receipt of user input indicative of an acceptance by a user associated with the one of the vehicles for payment of a fee for the advancement.

13. The vehicle charging control system of claim 1 wherein the vehicles are electric vehicles.

14. The vehicle charging control system of claim 1 wherein the vehicles are each at least partially autonomous.

15. The vehicle charging system of claim 1 wherein (d) the target charge levels of the batteries of the vehicles, respectively, at departure from the charging location are fixed predetermined values.

16. The vehicle charging system of claim 1 wherein (d) the target charge levels of the batteries of the vehicles, respectively, at departure from the charging location are set based on user input from mobile devices associated with the vehicles, respectively.

17. The vehicle charging system of claim 1 wherein the charging control module is configured to determine the (b) expected departure times of the vehicles, respectively, from the charging location based on average parking periods of the vehicles, respectively, at the charging location.

18. The vehicle charging system of claim 17 wherein the charging control module is configured to set the expected departure times of the vehicles based on (a) the arrival times of the vehicles, respectively, to the charging location and the average parking periods of the vehicles, respectively, at the charging location.

19. The vehicle charging system of claim 1 wherein the charging control module is configured to receive the (b) expected departure times of the vehicles, respectively, from the charging location from mobile devices of users associated with the vehicles, respectively.

20. A vehicle charging control method comprising:
providing, at a charging location, N parking locations for vehicles and M vehicle chargers, where N is an integer greater than or equal to two and M is an integer less than N and greater than or equal to 1; and
setting a charging sequence for charging vehicles at the charging location based on at least two of:
(a) arrival times of the vehicles, respectively, to the charging location;
(b) expected departure times of the vehicles, respectively, from the charging location;
(c) charge levels of batteries of the vehicles, respectively, at arrival to the charging location;
(d) target charge levels of the batteries of the vehicles, respectively, at departure from the charging location;
(e) credits of users of the vehicles, respectively; and
(f) premium fees approved by the users of the vehicles, respectively, for advancing in the charging sequence.
